(19) United States
(12) Patent Application Publication
(10) Pub. No.: US 2008/0139736 A1
(43) Pub. Date: Jun. 12, 2008

(54) AQUEOUS CURABLE RESIN COMPOSITION AND AQUEOUS COATING COMPOSITION

(75) Inventors: Shinya Yamada, Osaka (JP); Koji Nishizawa, Takahama-shi (JP); Akihiro Kanakura, Osaka (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: NIPPON PAINT CO., LTD, Osaka (JP)

(21) Appl. No.: 11/955,049

(22) Filed: Dec. 12, 2007

(30) Foreign Application Priority Data
Dec. 12, 2006 (JP) 2006-334004

(51) Int. Cl. C09D 11/10; C08L 51/00

(52) U.S. Cl. 524/514; 525/180; 525/66

(57) ABSTRACT

The present invention provides an aqueous curable resin composition which can provide a coating film having an excellent finished external appearance, and is excellent in coating workability (drip property), and an aqueous coating composition using the aqueous curable resin composition. The aqueous curable resin composition of the present invention includes a (meth)acrylic-modified polyester resin, (meth)acrylic resin particles having an average particle diameter of 0.1 to 2 μm, a melamine resin, and water.

This application claims priority under 35 U.S.C. Section 119 to Japanese Patent Application No. 2006-334004 filed on Dec. 12, 2006, which is herein incorporated by references.

### BACKGROUND OF THE INVENTION

1. Field of the Invention

The present invention relates to an aqueous curable resin composition and an aqueous coating composition, and more specifically, to an aqueous curable resin composition capable of improving, for example, the finished external appearance of a coating film and an aqueous coating composition using the aqueous curable resin composition.

2. Description of the Related Art

The improvement of the finished external appearance of a coating film to be formed by coating and an improvement in coating workability (drip property) have been desired in, for example, the outside plate of a vehicle such as an automobile or a two wheeler, a part, the external surface of a container, a coil coating, or a household electrical appliance.

An aqueous coating composition using a polyester resin, an acrylic resin, or a melamine resin as a vehicle has been proposed (JP 2002-241686 A). However, the composition has not sufficiently achieved compatibility between the improvement of the finished external appearance of a coating film and coating workability.

An aqueous intermediate coating composition containing a carboxyl group-containing aqueous polyester resin and a melamine resin has been proposed (JP 2002-294148 A). However, the aqueous intermediate coating composition involves the following problem: a reduction in viscosity of the composition or an increase in solid content of the composition results in poor coating workability.

There has been proposed that the finished external appearance and impact resistance of a coating film are improved by specifying the average particle diameters and numbers of an acrylic emulsion and a urethane emulsion (JP 2004-337670 A) However, the acrylic emulsion and the urethane emulsion are not compatible with each other in the coating film (see FIGS. 2 to 4 of JP 2004-337670 A), and the coating film becomes nonuniform, with the result that the improvement of the finished external appearance of the coating film is not sufficiently achieved.

### SUMMARY OF THE INVENTION

The present invention has been made with a view toward solving the above-mentioned conventional problems, and an object of the present invention is to provide an aqueous curable resin composition which: can provide a coating film having an excellent finished external appearance; and is excellent in coating workability (drip property), and an aqueous coating composition using the aqueous curable resin composition.

An aqueous curable resin composition of the present invention includes a (meth) acrylic-modified polyester resin, (meth) acrylic resin particles having an average particle diameter of 0.1 to 2 μm, a melamine resin, and water.

In a preferred embodiment of the present invention, the (meth)acrylic resin particles are incorporated at a content of 1 to 30 parts by weight with respect to 100 parts by weight of the total resin solid content in the aqueous curable resin composition.

In a preferred embodiment of the present invention, the (meth)acrylic resin particles have an average particle diameter of 0.3 to 1 μm.

In a preferred embodiment of the present invention, each of the (meth)acrylic resin particles has a solubility parameter SP of 9 to 12.

In a preferred embodiment of the present invention, the melamine resin includes an imino group type melamine resin.

In a preferred embodiment, the aqueous curable resin composition of the present invention further includes a polyether polyol having a number average molecular weight of 400 to 1,500.

In a preferred embodiment of the present invention, the polyether polyol is incorporated at a content of 3 to 30 parts by weight with respect to 100 parts by weight of the total resin solid content in the aqueous curable resin composition.

In a preferred embodiment, the aqueous curable resin composition of the present invention further includes a block polyisocyanate compound.

In a preferred embodiment of the present invention, the block polyisocyanate compound is incorporated at a content of 3 to 30 parts by weight with respect to 100 parts by weight of the total resin solid content in the aqueous curable resin composition.

In a preferred embodiment, the aqueous curable resin composition of the present invention further includes at least one of a urethane association type thickening agent and an alkali-thickening type thickening agent having a carboxylic acid neutralizing group.

According to another aspect of the present invention, there is provided an aqueous coating composition. The aqueous coating composition contains the aqueous curable resin composition of the present invention and a pigment.

According to the present invention, there can be provided an aqueous curable resin composition which can provide a coating film having an excellent finished external appearance, and is excellent in coating workability (drip property), and an aqueous coating composition using the aqueous curable resin composition.

Such effects can be achieved by constituting the aqueous curable resin composition by causing (1) a (meth) acrylic-modified polyester resin, (2) (meth)acrylic resin particles having a specific average particle diameter, (3) a melamine resin, and (4) water to coexist with one another.

### DETAILED DESCRIPTION OF THE PREFERRED EMBODIMENTS

### [Aqueous Curable Resin Composition]

An aqueous curable resin composition of the present invention contains a (meth)acrylic-modified polyester resin, (meth)acrylic resin particles having an average particle diameter of 0.1 to 2 μm, a melamine resin, and water.

The term “(meth)acrylic” as used in the present invention refers to “acrylic or methacrylic”.

### A. (Meth)Acrylic-Modified Polyester Resin

Any appropriate (meth) acrylic-modified polyester resin can be adopted as the (meth) acrylic-modified polyester resin that can be used in the present invention. The improvement of the finished external appearance of a coating film can be achieved because subjecting a polyester resin to (meth)acrylic modification can improve compatibility between the polyester resin and a (meth)acrylic resin particle to provide a uniform coating film. Although the polyester resin involves a problem in poor storage stability because the ester bond of the main chain of the resin is apt to hydrolyze, the hydrolysis can be suppressed by subjecting the resin to (meth)acrylic modification.

The above (meth)acrylic-modified polyester resin is incorporated at a content of preferably 20 to 90 parts by weight, or more preferably 25 to 80 parts by weight with respect to 100 parts by weight of the total resin solid content in the aqueous curable resin composition of the present invention. Effects of the present invention can be additionally expressed when the content of the above (meth)acrylic-modified polyester resin falls within the above range.

The (meth) acrylic-modified polyester resin that can be used in the present invention is obtained by, for example, subjecting an unsaturated polyester resin and a polymerizable unsaturated (meth)acrylic monomer containing a carboxyl group-containing polymerizable unsaturated monomer to graft polymerization or causing a (meth)acrylic-modified fatty acid to react with a hydroxyl group-containing polyester resin.

Any appropriate unsaturated polyester resin and any appropriate hydroxyl group-containing polyester resin can be adopted as the above unsaturated polyester resin and the above hydroxyl group-containing polyester resin. Examples of the unsaturated polyester resin include those each obtained as a result of a condensation reaction between a polybasic acid containing an unsaturated polybasic acid and a polyhydric alcohol having an allyl ether unit. Each of the above unsaturated polyester resin and the above hydroxyl group-containing polyester resin has a number average molecular weight of preferably 500 to 10,000.

Examples of the unsaturated polybasic acid include maleic acid, maleic anhydride, fumaric acid, itaconic acid, itaconic anhydride, tetrahydrophthalic acid, tetrahydrophthalic anhydride, methyltetrahydrophthalic anhydride, tetrabromophthalic anhydride, tetrachlorophthalic anhydride, HET anhydride, and himic anhydride. Those can be used alone or two or more kinds thereof can be used in combination.

A saturated polybasic acid may be used with the unsaturated polybasic acid. Examples of the saturated polybasic acid include phthalic acid, phthalic anhydride, halogenated phthalic anhydride, isophthalic acid, terephthalic acid, hexahydrophthalic acid, hexahydrophthalic anhydride, hexahydroterephthalic acid, hexahydroisophthalic acid, succinic acid, malonic acid, glutaric acid, adipic acid, sebacic acid, 1,12-dodecanoic-2-acid, 2,6-naphthalenedicarboxylic acid, 2,7-naphthalenedicarboxylic acid, 2,3-naphthalenedicarboxylic acid, 2,3-naphthalenedicarboxylic anhydride, 4,4′-biphenyldicarboxylic acid, and dialkylesters thereof. Those can be used alone or two or more kinds thereof can be used in combination.

Examples of the polyalcohols include ethylene glycol, diethylene glycol, triethylene glycol, polyethylene glycol, propylene glycol, dipropylene glycol, polypropylene glycol, 2-methyl-1,3-propanediol, 1,3-butanediol, neopentyl glycol, hydrogenated bisphenol A, 1,4-butanediol, 1,6-hexanediol, 1,9-nonanediol, dimethylolbutanoic acid, addition products of bisphenol A with propylene oxide or ethylene oxide, 1,2,3,4-tetrahydroxybutane, glycerin, trimethylolpropane, 1,3-propanediol, 1,2-cyclohexane glycol, 1,3-cyclohexane glycol, 1,4-cyclohexane glycol, 1,4-cyclohexane dimethanol, paraxylene glycol, bicyclohexyl-4-4′-diol, 2,6-decalin glycol, 2,7-decalin glycol, and bishydroxy ethylterephthalate. Those can be used alone or two or more kinds thereof can be used in combination.

An allyl compound having a hydroxyl group, such as an allyl ether of a polyhydric alcohol may be used as a production raw material for each of the above unsaturated polyester resin and the above hydroxyl group-containing polyester resin. Examples of the allyl compounds include ethylene glycol monoallyl ether, diethylene glycol monoallyl ether, triethylene glycol monoallyl ether, polyethylene glycol monoallyl ether, propylene glycol monoallyl ether, dipropylene glycol monoallyl ether, tripropylene glycol monoallyl ether, polypropylene glycol monoallyl ether, 1,2-butylene glycol monoallyl ether, 1,3-butylene glycol monoallyl ether, hexylene glycol monoallyl ether, octylene glycol monoallyl ether, trimethylolpropane diallyl ether, glycerin diallyl ether, and pentaerythritol triallyl ether. Those can be used alone or two or more kinds thereof can be used in combination.

Each of the above unsaturated polyester resin and the above hydroxyl group-containing polyester resin may be modified with a fatty acid. Examples of the fatty acid include saturated fatty acids, and a drying oil fatty acid and a semi-drying oil fatty acid as unsaturated fatty acids. Specific examples of the saturated fatty acids include coconut oil fatty acid and palm kernel oil fatty acid, and specific examples of the unsaturated fatty acids include fish oil fatty acid, dehydrated castor oil fatty acid, safflower oil fatty acid, linseed oil fatty acid, soybean oil fatty acid, sesame oil fatty acid, poppy oil fatty acid, perilla oil fatty acid, hempseed oil fatty acid, grape kernel oil fatty acid, corn oil fatty acid, tall oil fatty acid, sunflower oil fatty acid, cotton oil fatty acid, walnut oil fatty acid, rubber seed oil fatty acid, and Hidiene fatty acid. Only one kind thereof may be used, or two or more kinds thereof may be used in combination.

The polymerizable unsaturated (meth)acrylic monomer has a carboxyl group-containing polymerizable unsaturated monomer such as acrylic acid, methacrylic acid, itaconic acid, and fumaric acid as the essential component, and may contain another polymerizable unsaturated (meth)acrylic monomer where necessary. Examples of another polymerizable unsaturated (meth)acrylic monomer include: alkylesters having 1 to 18 carbon atoms of an acrylic acid or methacrylic acid, such as methyl(meth)acrylate, ethyl(meth)acrylate, propyl(meth)acrylate, n-butyl(meth)acrylate, iso-butyl(meth)acrylate, tert-butyl(meth)acrylate, 2-ethylhexyl(meth)acrylate, lauryl(meth)acrylate, benzyl(meth)acrylate, stearyl(meth)acrylate, and cetyl(meth)acrylate; cyclohexyl(meth)acrylate and isobornyl(meth)acrylate; aromatic vinyl monomers such as styrene, α-methylstyrene, and vinyltoluene; hydroxyalkyl(meth)acrylates such as hydroxyethyl(meth)acrylate, hydroxypropyl(meth)acrylate, hydroxybutyl(meth)acrylate, hydroxyamyl(meth)acrylate, and hydroxyhexyl(meth)acrylate, and a hydroxyl group-containing polymerizable unsaturated monomer such as caprolactone-modified alkyl(meth)acrylate which is obtained by ring-opening additioning 1 to 5 mol of ε-caprolactam per mol of the hydroxyalkyl(meth)acrylate; acrylamide-based monomers such as acrylamide, methacrylamide, N-methoxymethyl(meth)acrylamide, N-ethoxymethyl(meth)acrylamide, N-n-propoxymethyl(meth)acrylamide, N-isopropoxymethyl(meth)acrylamide, N-n-butoxymethyl(meth)acrylamide, N-sec-butoxymethyl(meth)acrylamide, and N-tert-butoxymethyl(meth)acrylamide; and acrylonitrile, methacrylonitrile, vinyl acetate, ethylene, and butadiene. Those can be used alone or two or more kinds thereof can be used in combination. Note that in the present invention, the term “(meth)acrylate” means acrylate or methacrylate.

Any appropriate method can be adopted as a method of producing the (meth) acrylic-modified polyester resin by subjecting the above unsaturated polyester resin and the above polymerizable unsaturated (meth) acrylic monomer to graft polymerization. For example, free radical polymerization in an organic solvent can be employed. A specific example of the method involves: adding the above unsaturated polyester resin, the above polymerizable unsaturated (meth) acrylic monomer, a radical polymerization initiator, and, as required, a chain transfer agent; and heating the mixture at 90 to 120° C. for 1 to 5 hours. A compounding ratio (weight ratio) between the above unsaturated polyester resin and the above polymerizable unsaturated (meth)acrylic monomer is preferably 40/60 to 95/5.

Examples of the above polymerization initiator include an organic peroxide-based polymerization initiator and an azo-based polymerization initiator. Examples of the organic peroxide-based polymerization initiator include benzoyl peroxide, t-butylperoxy-2-ethylhexanoate, di-t-butylperoxide, t-butylperoxybenzoate, and t-amylperoxy-2-ethylhexanoate. Examples of the azo-based polymerization initiator include azobisisobutyronitrile and azobisdimethylvaleronitrile. Examples of the above chain transfer agent include α-methylstyrene dimers and mercaptans. Only one kind thereof may be used, or two or more kinds thereof may be used in combination.

The (meth)acrylic-modified polyester resin may be neutralized. A neutralizer to be used for the neutralization is, for example, any one of the amines or ammonia. Examples of the above amines include triethylamine, triethanolamine, dimethylethanolamine, diethylethanolamine, and morpholine. Of those, triethylamine and dimethylethanolamine are preferable. Only one kind thereof may be used, or two or more kinds thereof may be used in combination.

Any appropriate (meth)acrylic-modified fatty acid can be adopted as the above (meth) acrylic-modified fatty acid. The fatty acid can be obtained by, for example, polymerizing such polymerizable unsaturated (meth) acrylic monomer as described above in the presence of an unsaturated fatty acid out of such fatty acids as described above.

### B. (Meth)Acrylic Resin Particles

Any appropriate (meth) acrylic resin particles can be adopted as the (meth) acrylic resin particles that can be used in the present invention as long as the particles adopted have an average particle diameter of 0.1 to 2 μm. The incorporation of (meth)acrylic resin particles having an average particle diameter of 0.1 to 2 μm into the aqueous curable resin composition of the present invention can: increase the solid content of the composition; and improve the performance of a coating film made of the composition, such as water resistance.

The above (meth)acrylic resin particles have an average particle diameter of 0.1 to 2 μm, preferably 0.3 to 1 μm, or more preferably 0.3 to 0.8 μm. It should be noted that the term “average particle diameter of resin particles” refers to a volume average particle diameter, which is a value obtained by measuring the volume average particle diameter of a sample diluted with deionized water by using a laser scattering particle size distribution measuring device (trade name ELS-800 manufactured by OTSUKA ELECTRONICS CO., LTD.) at 25° C.

When the above (meth) acrylic resin particles have an average particle diameter of less than 0.1 μm, an increasing effect of the particles on the solid content concentration of the composition may reduce. When the above (meth)acrylic resin particles have an average particle diameter in excess of 2 μm, the particles may precipitate with a lapse of time.

Each of the above (meth) acrylic resin particles has a solubility parameter SP of 9 to 12. When the solubility parameter SP is smaller than 9, it may be difficult to produce the composition. When the solubility parameter SP is larger than 12, compatibility between each of the particles and the (meth)acrylic-modified polyester resin may reduce.

The term “solubility parameter” as used in the specification of the present invention refers to a parameter proposed by Hildebrand, and is defined as the square root of a cohesive energy density. The solubility parameters of representative solvents and resins are described in, for example, the Polymer Handbook. In the specification of the present invention, the solubility parameter of a resin is determined by, for example, the following procedure. 0.5 g of the resin is precisely weighed and loaded into a beaker. 10 ml of a good solvent (such as acetone, dioxane, butyl cellosolve, or THF) are added to the beaker with a whole pipette to dissolve the resin, whereby a resin solution is prepared. The temperature of the resin solution is kept at 20° C., water or hexane is dropped to the solution, and the amount of water or hexane in which the solution becomes opaque is defined as a titration value. The solubility parameter δᵣₑₛᵢₙ of the resin is calculated from the titration value by using the following equation:

$${δ}_{re sin} = \sqrt{\frac{\sqrt{{V}_{m l}} \cdot {δ}_{m l}^{2} + \sqrt{{V}_{mh}} \cdot {δ}_{mh}^{2}}{\sqrt{{V}_{m l}} + \sqrt{{V}_{mh}}}}$$

where Vₘₗ represents the molecular volume of the mixed solvent at the time of the completion of the titration with hexane, Vₘₕ represents the molecular volume of the mixed solvent at the time of the completion of the titration with water, and δₘₗ and δₘₕ represent the solubility parameter of the mixed solvent at the time of the completion of the titration with hexane and the solubility parameter of the mixed solvent at the time of the completion of the titration with water, respectively, and are represented by the following equations:

δₘₗ=\sqrt{φₘₗδₕₑₓₐₙₑ²+(1−φₘₗ)δ_{g}²} δₘₕ=\sqrt{φₘₕδ_{water}²+(1−φₘₕ)δ_{g}²}

where δ_{water} and δₕₑₓₐₙₑ represent the solubility parameter of water and the solubility parameter of hexane, respectively, δ_{g} represents the solubility parameter of the good solvent, φₘₗ represents the volume fraction of hexane in the mixed solvent, and φₘₕ represents the volume fraction of water in the mixed solvent.

The above (meth) acrylic resin particles are incorporated at a content of preferably 1 to 30 parts by weight, or more preferably 3 to 20 parts by weight with respect to 100 parts by weight of the total resin solid content in the aqueous curable resin composition of the present invention. The effects of the present invention can be additionally expressed when the content of the above (meth) acrylic resin particles falls within the above range.

The (meth)acrylic resin particles that can be used in the present invention can be produced by any appropriate method. A representative method of producing the particles is a method of producing the particles as a water dispersion by an emulsion polymerization process, a suspension polymerization process, or a post emulsification process. A method of producing the particles as a water dispersion by an emulsion polymerization process in water is preferred because the method can be performed through simple steps without taking the remaining of an organic solvent into consideration. A specific method of producing the particles involves subjecting an ethylenically unsaturated monomer to a reaction in water at 40 to 100° C. for 2 to 10 hours in the presence of 0.2 to 10 wt % of an emulsifier of the monomer by using 0.1 to 5 wt % of a radical polymerization initiator and an appropriate amount of a chain transfer agent.

Examples of the ethylenically unsaturated monomer include acrylic acid, methacrylic acid, and alkylesters thereof such as methylester, ethylester, isobutylester, sec-butylester, tert-butylester, and 2-ethylhexylester, laurylester as the essential component, and the ethylenically unsaturated monomer may contain other vinyl compounds where necessary. Those can be used alone or two or more kinds thereof can be used in combination.

Examples of the other vinyl compounds include styrenes such as styrene and methylstyrene; carboxylic acids such maleic acid and itaconic acid; hydroxyalkyl esters of acrylic acid or methacrylic acid, such as hydroxyethyl ester, hydroxypropyl ester, and hydroxybutyl ester; nitriles such as (meth) acrylonitrile; and amides such as (meth)acrylamide, N-methylolacrylamide, N,N-dimethylacrylamide, and N-isopropylacrylamide. Those can be used alone or two or more kinds thereof can be used in combination.

Examples of the above polymerization initiator include: persulfates such as ammonium persulfate and potassium persulfate; peroxides such as t-butylhydroperxoide and hydrogen peroxide; redox initiator systems each obtained by, for example, combining a reducing agent such as sodium hydrogen sulfite, sodium sulfite, ascorbic acid, or Rongalite and an oxidizing agent such as any one of the above initiators; and azo compounds of 4,4′-azobis-4-cyanovaleric acid. Only one kind thereof may be used, or two or more kinds thereof may be used in combination.

Examples of the emulsifier include nonionic emulsifiers such as dodecylbenzenesulfonate, lauryl sulfate, alkyldiphenylether disulfonate, dialkylsulfosuccinate, polyoxyethylene alkylphenylether sulfate, polyoxyethylene polycyclic phenylether sulfate, polyoxyethylene alkylether sulfate; anionic emulsifiers such as polyoxyethylene alkylphenylether, polyoxyethylene alkylether, polyoxyethylene polycyclic phenylether, and polyoxyethylene sorbitan fatty ester; and anion type or nonion type emulsifiers, which have radical polymerizable groups, that is, reactive emulsifiers such as AQUALON HS-10 (polyoxyethylene alkylpropenylphenyl ether sulfonate manufactured by Dai-ichi Kogyo Seiyaku Co., Ltd.), AQUALON RN-20 (polyoxyethylene alkylpropenyl phenylether manufactured by Dai-ichi Kogyo Seiyaku Co., Ltd.), ELEMENOL JS-2 (alkylaryl sodium sulfosuccinate manufactured by Sanyo Chemical Industries, Ltd.), LATEMUL S-180A (sulfosuccinate type reactant (oleylammonium salt) manufactured by Kao Corporation), and ANDOX MS-60 (bis(polyoxyethylene polycyclic phenylether)methacrylate sulfonate manufactured by Nippon Nyukazai Co., Ltd.). Those can be used alone or two or more kinds thereof can be used in combination.

Examples of the chain transfer agent include laurylmercaptan, t-dodecylmercaptan, octylmercaptan, 2-ethylhexyl thioglycolate, and 2-methyl-5-t-butylthiophenol. Those can be used alone or two or more kinds thereof can be used in combination.

The (meth)acrylic resin particles that can be used in the present invention are preferably used in the form of such water dispersion as described above upon production of the aqueous curable resin composition of the present invention.

### C. Melamine Resin

General examples of the melamine resin include four kinds: a complete alkyl type melamine resin using N— (CH₂OR)₂ as a reactive group, a methylol group type melamine resin using N—(CH₂OR)CH₂OH as a reactive group, an imino group type melamine resin using N—(CH₂OR)H as a reactive group, and a methylol/imino group type melamine resin in which N—(CH₂OR)CH₂OH and N—(CH₂OR)H are simultaneously present. The melamine resin to be incorporated into the aqueous curable resin composition of the present invention is preferably a methylol group type melamine resin, an imino group type melamine resin, or a methylol/imino group type melamine resin, or is particularly preferably an imino group type melamine resin. Only one kind thereof may be used, or two or more kinds thereof may be used in combination. R in each of the above reactive groups can be any appropriate alkyl group. The melamine resin to be used in the present invention has a number average molecular weight of preferably 200 to 2,000, or more preferably 300 to 1,000.

Any appropriate melamine resin can be adopted as the melamine resin to be incorporated into the aqueous curable resin composition of the present invention. For example, a commercial product can be adopted as the resin. Specific examples of the commercial product include Mycoat 723 (manufactured by Nihon Cytec Industries, Inc.), Cymel 212 (manufactured by Nihon Cytec Industries, Inc.), Cymel 238 (manufactured by Nihon Cytec Industries, Inc.), Cymel 327 (manufactured by Nihon Cytec Industries, Inc.), and U-VAN 226 (manufactured by Mitsui Chemicals, Inc.).

The above melamine resin is incorporated at a content of preferably 10 to 40 parts by weight, or more preferably 15 to 30 parts by weight with respect to 100 parts by weight of the total resin solid content in the aqueous curable resin composition of the present invention. The effect of the present invention can be additionally expressed when the content of the above melamine resin falls within the above range.

### D. Polyether Polyol

The aqueous curable resin composition of the present invention may further contain a polyether polyol having a number average molecular weight of 400 to 1,500. Any appropriate polyether polyol can be adopted as the above polyether polyol as long as the polyether polyol adopted has two or more hydroxyl groups per molecule. Only one kind thereof may be used, or two or more kinds thereof may be used in combination. Such constitution can improve the water resistance and adhesiveness of a coating film to be obtained. The upper limit for the number of hydroxyl groups in one molecule of the polyether polyol to be used in the present invention is preferably 6, or more preferably 4 because the coating film can be excellent in curing property and water resistance.

The above polyether polyol has a number average molecular weight of 400 to 1,500, or preferably 500 to 1,200. When the number average molecular weight is less than 400, the curing property of the coating film may reduce. When the number average molecular weight exceeds 1,500, the viscosity of the composition increases, with the result that compatibility between the polyether polyol and the above (meth) acrylic-modified polyester resin may reduce, and the coating film may become cloudy.

The above polyether polyol has a hydroxyl value of preferably 30 to 700, or more preferably 50 to 500. When the hydroxyl value deviates from the range, the storage stability of the composition may reduce, or various properties of a coating film to be obtained may reduce.

The above polyether polyol can be produced by any appropriate method. For example, the polyether polyol can be obtained by adding an alkylene oxide to an active hydrogen atom-containing compound in the presence of an alkali catalyst by an ordinary method under normal pressure or increased pressure at a temperature of 60 to 160° C.

Examples of the an active hydrogen atom-containing compounds include: water; polyvalent alcohols such as 1,6-hexanediol, neopentyl glycol, and polyglycerine; tetravalent alcohols such as diglycerine and sorbitan; pentavalent alcohols such as adonitol, arabitol, xylitol, and triglycerine; hexavalent alcohols such as dipentaerythritol, sorbitol, mannitol, iditol, inositol, dulcitol, talose, and allose; octavalent alcohols such as saccharose; polyphenols such as pyrogallol, hydroquinone, phloroglucin, and bisphenols including bisphenol A and bisphenol sulfone; polycarobxylates such as adipic acid and maleic anhydride; and a mixture of two or more kinds thereof. As an alcohol having three or more valence used to produce a polyetherpolyol having total hydroxyl groups of 3 or more per molecule, glycerine, trimethylolethane, trimethylolpropane, pentaerythritol, sorbitan and sorbitol are preferred.

Examples of the above alkylene oxide include alkylene oxides such as ethylene oxide, propylene oxide, and butylene oxide. Two or more kinds thereof can be used in combination. When two or more kinds of the alkylene oxides are used in combination, the oxides may be added to the active hydrogen atom-containing compound in either a block fashion or a random fashion.

A commercial product can be adopted as the polyether polyol to be used in the present invention. Specific examples of the commercial product include a Primepol PX-1000, a Sannix GE-600, a Sannix SP-750, and a Sannix PP-400 (each of which is manufactured by Sanyo Chemical Industries, Ltd.), and a PTMG-650 (manufactured by Mitsubishi Chemical Corporation).

The above polyether polyol is incorporated at a content of preferably 3 to 30 parts by weight, or more preferably 5 to 25 parts by weight with respect to 100 parts by weight of the total resin solid content in the above aqueous curable resin composition. When the content of the above polyether polyol in the above aqueous curable resin composition is smaller than 3 parts by weight, the flow property of the composition may be insufficient, and the substrate-hiding property of the composition may reduce. When the content is larger than 30 parts by weight, the hardness of a coating film made of the composition may be insufficient, and the solvent resistance of the coating film may reduce.

### E. Block Polyisocyanate Compound

The aqueous curable resin composition of the present invention may further contain a block polyisocyanate compound.

Any appropriate block polyisocyanate compounds can each be adopted as the above block polyisocyanate compound. Only one kind thereof may be used, or two or more kinds thereof may be used in combination. A preferable block polyisocyanate compound is such that a diisocyanate compound is blocked with a proper blocking agent.

The block polyisocyanate compound preferably has a compound having 2 or more isocyanate groups per molecule. Specifically, for example, aliphatic diisocyanates such as hexamethylene diisocyanate (HMDI) and trimethylhexamethylene diisocyanate (TMDI); alicyclic diisocyanates such as isophorene diisocyanate (IPDI); aromatic-aliphatic diisocyanates such as xylylene diisocyanate (XDI); aromatic diisocyanates such as tolylene diisocyanate (TDI) and 4,4-diphenylmethane diisocyanate (MDI); hydrogenated diisocyanates such as dimer acid diisocyanate (DDI), hydrogenated TDI (HTDI), hydrogenated XDI (H6XDI), and hydrogenated MDI (H₁₂MDI); and adducts and nurates thereof are mentioned.

Any appropriate blocking agent may be used as the blocking agent. For example, oximes such as methylethylketoxime, acetoxime, and cyclohexanone oxime; phenols such as m-cresol and xylenol; alcohols such as butanol, 2-ethylhexanol, cyclohexanol, and ethylene glycol monoethylether; lactams such as ε-caprolactam; diketones such as diethyl malonate and acetoacetic ester; mercaptanes such as thiophenol; ureas such as thiourea; imidazoles; and carbamines are mentioned. Of those, oximes, phenols, alcohols, lactams and diketones are preferable.

The above block polyisocyanate compound is incorporated at a content of preferably 3 to 30 parts by weight, or more preferably 5 to 25 parts by weight with respect to 100 parts by weight of the total resin solid content in the aqueous curable resin composition of the present invention. When the content of the above block polyisocyanate compound falls within the above range, toughness can be imparted to a coating film made of the composition, and, for example, the chipping resistance of the coating film is improved.

### F. Thickening Agent

The aqueous curable resin composition of the present invention may further contain a thickening agent.

Examples of the thickening agents include cellulose types such as viscose, methylcellulose, ethylcellulose, hydroxyethylcellulose, and commercially available products including TYROSE MH and TYROSE H (each of which is manufactured by Hoechst Corporation); alkali thickening types such as sodium polyacrylate, polyvinylalcohol, and carboxymethylcellulose, and commercially available products including Primal ASE-60, Primal TT-615, and Primal RM-5 (all of which are manufactured by Rohm and Haas) and UKARPOLIFORB (manufactured by Union Carbide Corporation); nonionic types such as polyvinylalcohol and polyethyleneoxide, and commercially available products including ADECANOL UH-420, ADECANOL UH-462, and ADECANOL UH-472 (all of which are manufactured by Asahi Denka Co., Ltd.), Primal RH-1020 (manufactured by Rohm and Haas), and KURARAY POVAL (manufactured by Kuraray Co.) urethane conjuncted types having an urethane bond within the amphiphilic molecule such as commercially available products including ADECANOL SDX-1014 (manufactured by Asahi Denka Co., Ltd.); polyamide types such as commercially available products including DISPALON AQ-610 (manufactured by Kusumoto Chemicals, Ltd.) and CHICZOLE W-300P (manufactured by Kyoeisha Co., Ltd.); and inorganic types such as clay, including bentonite having montmorillonite as the main component, hectonite, and sapponite, commercially available products including BENTON AD (manufactured by Elementes Corporation), and commercially available products having synthetic hectonite as the main component including LAPONITE (manufactured by TOMOE Engineering Co., Ltd.) and LUCENTITE (manufactured by CO-OP Chemical Co., Ltd.).

Of the above thickening agents, each of a urethane association type thickening agent having a urethane bond per molecule and an alkali-thickening type thickening agent having a carboxylic acid neutralizing group can be additionally preferably used in the present invention because each of the agents exerts a high viscosity imparting effect in an aqueous coating composition.

One kind of the above thickening agents may be used alone, or multiple kinds thereof may be used in combination.

The addition amount of the above thickening agent is preferably 0.01 to 10 parts by weight, or more preferably 0.05 to 5 parts by weight with respect to the resin solid content of the aqueous curable resin composition. When the addition amount is less than 0.01 part by weight, a sufficient controlling effect on the viscosity of the composition may not be obtained. When the addition amount exceeds 10 parts by weight, the flow property of the composition is extremely impaired, with the result that the external appearance of a coating film made of the composition may deteriorate.

### G. Other Component

The aqueous curable resin composition of the present invention may contain any appropriate other component. For example, the composition may contain an organic solvent, a surfactant, a curing catalyst, a surface adjustor, a defoaming agent, a plasticizer, a film-forming auxiliary, a UV absorber, or an antioxidant.

### H. Method of Producing Aqueous Curable Resin Composition of the Present Invention

Any appropriate method can be adopted as a method of producing the aqueous curable resin composition of the present invention. An example of the method involves: dispersing a blend containing the above resin and the like with a sand grind mill, a paint conditioner, a disper, or the like; and kneading the dispersed product with a kneader, a roll, or the like.

### [Aqueous Coating Composition]

An aqueous coating composition of the present invention contains the aqueous curable resin composition of the present invention and a pigment.

Any appropriate pigment can be adopted as the above pigment.

Examples of the pigment include: coloring pigments such as chrome yellow, yellow oxide, iron oxide, carbon black, titanium dioxide, an azochelate-based pigment, an insoluble azo-based pigment, a condensed azo-based pigment, a phthalocyanine-based pigment, an indigo pigment, a perynone-based pigment, a perylene-based pigment, a dioxane-based pigment, a quinacridone-based pigment, an isoindolinone-based pigment, and a metal complex pigment; and loading pigments such as calcium carbonate, sedimentary barium sulfate, clay, and talc.

The above pigment may contain a flat pigment because the aqueous coating composition of the present invention may be suitable particularly for intermediate coating when the above pigment contains the flat pigment.

When the above pigment contains the flat pigment, the flat pigment is incorporated at a content of preferably 1 to 12 parts by weight with respect to 100 parts by weight of the pigment.

In the aqueous coating composition of the present invention, a total pigment concentration represented by (total pigment weight/(total pigment weight+total resin solid content weight))×100 is preferably 20 to 60 wt %, or more preferably 30 to 55 wt %. When the total pigment concentration is less than 20 wt %, it becomes difficult to design the color of a coating made of the composition, and the weatherability of a coating film made of the coating may reduce. When the total pigment concentration exceeds 60 wt %, the stability of the coating may reduce.

Any appropriate method can be adopted as a method of producing the aqueous coating composition of the present invention. An example of the method involves: dispersing a blend containing the above resin, the above pigment, and the like with a sand grind mill, a paint conditioner, a disper, or the like; and kneading the dispersed product with a kneader, a roll, or the like.

The aqueous coating composition of the present invention is applicable to any appropriate coating film forming application. The composition is used in, for example, a top coating or an intermediate coating.

The aqueous coating composition of the present invention is typically used in the formation of a coating film as a result of its application to a product to be coated by any appropriate method.

Examples of the method of applying the composition include air spraying, airless spraying, and electrostatic rotary atomizing coating. The thickness of a coating film to be obtained can be set to any appropriate thickness depending on, for example, purposes. In general, the thickness of the coating film in a dry state is preferably 10 to 40 μm.

Further, the resultant coating film may be cured by heating. Curing the coating film by heating can improve the physical properties and various properties of the coating film. The temperature at which the coating film is heated can be appropriately set depending on the kind of the aqueous coating composition of the present invention. In general, the temperature is preferably set to 80 to 180° C. The time period for which the coating film is heated can be freely set depending on the temperature at which the coating film is heated.

Hereinafter, the present invention will be described in more detail by way of examples. However, the present invention is not limited to these examples. It should be noted that the terms “part(s)” and “%” in each example represent “part(s) by weight” and “wt %”, respectively unless otherwise stated.

### Production Example 1

### Production of Acrylic-Modified Polyester Resin Solution (A)

9.14 parts of phthalic anhydride, 10.25 parts of isophthalic acid, 35.08 parts of adipic acid, 1 part of maleic anhydride, 0.09 part of trimethylolpropane, 41.77 parts of neopentyl glycol, 2.66 parts of dimethylolbutanoic acid, and 0.1 part of dibutyltin oxide as a catalyst were loaded into a reaction vessel provided with a stirrer, a condenser, and a temperature gauge. The temperature of the mixture was increased from 150° C. to 230° C. over 3 hours, and was kept at 230° C. for about 7 hours, whereby an unsaturated polyester resin having a solid content acid value of 8.0, a solid content hydroxyl value of 60, and a number average molecular weight of 3,000 was obtained.

After that, 87.69 parts of the unsaturated polyester resin were loaded into the reaction vessel and heated to 150° C. A monomer solution composed of 2.07 parts of methacrylic acid, 3.84 parts of lauryl methacrylate, and 3.84 parts of styrene, and an initiator solution composed of 2.00 parts of a KAYABUTYL B (manufactured by KAYAKU AKZO CO., LTD.) and 5.0 parts of dipropylene glycol methyl ether were dropped in tandem to the reaction vessel over 2 hours. After the completion of the dropping, the mixture was aged for 0.5 hour at the temperature.

Further, the initiator solution composed of 2.00 parts of a KAYABUTYL B (manufactured by KAYAKU AKZO CO., LTD.) and 5.0 parts of dipropylene glycol methyl ether was dropped to the reaction vessel over 0.5 hour. After the completion of the dropping, the mixture was aged for 1 hour at the temperature.

94.54 parts of deionized water and 2.90 parts of dimethylaminoethanol were added to the mixture, whereby Acrylic-modified Polyester Resin Solution (A) was obtained. Acrylic-modified Polyester Resin Solution (A) thus obtained had a nonvolatile content of 50.0%, a solid content acid value of 30, a hydroxyl value of 54, a number average molecular weight of 3,500, and a neutralization ratio of 90%.

### Production Example 2

### Production of Hydroxyl Group-Containing Polyester Resin (B-1)

161 parts of isophthalic acid, 330 parts of adipic acid, 53 parts of soybean oil fatty acid, 101 parts of neopentyl glycol, 44 parts of 1,6-hexanediol, 311 parts of trimethylolpropane, and 0.5 part by weight of dibutyltin oxide were loaded into a 3-liter four-necked flask provided with a stirrer, a temperature gauge, a reflux condenser with a dehydration trap, and a nitrogen gas-introducing pipe. The temperature of the mixture was increased up to 220° C., and the mixture was subjected to a dehydration condensation reaction. At this time, the reaction was continued until the resin solid content of the mixture had an acid value of 16 KOHmg/g, whereby Hydroxyl Group-containing Polyester Resin (B-1) in a solid state having a hydroxyl value of 190 and a weight average molecular weight of 9,200 as a raw material for Acrylic-modified Polyester Resin (B) was obtained.

### Production Example 3

### Production example of Acrylic-Modified Fatty Acid (B-2)

356 parts of castor oil fatty acid and 650 parts of xylene were loaded into a 3-liter four-necked flask provided with a stirrer, a temperature gauge, a reflux condenser, and a nitrogen gas-introducing pipe. The temperature of the mixture was increased up to 130° C. while the mixture was stirred. A mixture composed of 172 parts of styrene, 257 parts of i-butyl methacrylate, 215 parts of methacrylic acid, and 30 parts of t-butylperoxybenzoate was added to the foregoing mixture over 3 hours. The resultant mixture was stirred overnight at 130° C., and its temperature was reduced to 80° C. After that, 350 parts of methyl ethyl ketone were added to the mixture, whereby a solution of Acrylic-modified Fatty Acid (B-2) having a weight average molecular weight of 6,400 and a nonvolatile content of 50 wt % was obtained.

### Production Example 4

### Production Example of Acrylic-Modified Polyester Resin (B)

760 parts of Polyester Resin (B-1) and 240 parts of Acrylic-modified Fatty Acid (B-2) were loaded into a 3-liter four-necked flask provided with a stirrer, a temperature gauge, a reflux condenser with a dehydration trap, and a nitrogen gas-introducing pipe. The temperature of the mixture was gradually increased up to 180° C., xylene and methyl ethyl ketone were removed by distillation, and the remainder was subjected to a dehydration condensation reaction. Here, the reaction was continued until the resin solid content of the remainder had an acid value of 35. After the completion of the reaction, the resultant was cooled to 150° C., and, at the time point, 50 parts of propylene glycol n-propyl ether were added to the resultant. Next, the mixture was stirred for 1 hour, 42 parts of dimethylethanolamine were added to the mixture at 90° C., and the whole was stirred at the temperature for 1 hour. After that, ion-exchanged water was added to the resultant so that the resultant would have a nonvolatile content of 40 wt %, whereby a water dispersion of Acrylic-modified Polyester Resin (B) having a hydroxyl value of 138 and a weight average molecular weight of 55,000 was obtained.

### Production Example 5

### Production example of Acrylic Resin Particles (C)

95 parts of deionized water were charged into an ordinary reaction vessel for the production of an acrylic resin emulsion including a stirrer, a temperature gauge, a dropping funnel, a reflux condenser, and a nitrogen-introducing pipe, and were heated to 80° C. while being stirred. A monomer mixed liquid composed of 26 parts of methyl methacrylate, 4 parts of n-butyl acrylate, 50 parts of n-butyl methacrylate, and 20 parts of styrene, and a mixture obtained by mixing 50 parts of deionized water, 1.5 parts of an Adekalia Soap ER-20 (manufactured by ADEKA CORPORATION, nonionic reactive emulsifier, 75% aqueous solution), and 1.5 parts of a Neugen EA-137 (manufactured by Dai-ichi Kogyo Seiyaku Co., Ltd., nonionic non-reactive emulsifier, active ingredient 100%) were emulsified with a homogenizer. The monomer pre-emulsion emulsified with the homogenizer was dropped to the reaction vessel over 3 hours while deionized water in the reaction vessel was stirred. In addition, in tandem with the dropping of the monomer pre-emulsion, an aqueous solution prepared by dissolving 0.3 part of ammonium persulfate (APS) as a polymerization initiator in 10 parts of water was dropped at a constant dropping rate to the reaction vessel till the completion of the dropping of the monomer pre-emulsion. After the completion of the dropping of the monomer pre-emulsion, the resultant mixture was continuously subjected to a reaction at 80° C. for an additional 1 hour, and was then cooled.

Acrylic Resin Particles (C) thus obtained each had a Tg of 48° C., an SP of 9.6, and a solid content of 40 wt %, and the particles had an average particle diameter of 450 nm.

### Production Example 6

### Production Example of Acrylic Resin Particles (D)

Acrylic Resin Particles (D) were obtained in the same manner as in Production Example 5 except that a monomer mixed liquid composed of 5 parts of methyl methacrylate, 10 parts of n-butyl acrylate, 50 parts of glycidyl methacrylate, and 35 parts of ethylhexyl methacrylate, and a mixture composed of 0.75 part of an Adekalia Soap ER-20 (manufactured by ADEKA CORPORATION, nonionic reactive emulsifier, 75% aqueous solution) and 0.75 part of a Neugen EA-137 (manufactured by Dai-ichi Kogyo Seiyaku Co., Ltd., nonionic non-reactive emulsifier, active ingredient 100%) were used.

Acrylic Resin Particles (D) thus obtained each had a Tg of 12° C., an SP of 10.0, and a solid content of 40 wt %, and the particles had an average particle diameter of 580 nm.

### Production Example 7

### Production of Coloring Pigment Paste 1

50 parts of Acrylic-modified Polyester Resin (A) obtained in Production Example 1 were mixed with 34.5 parts of rutile titanium oxide, 34.4 parts of barium sulfate, 6 parts of talc, 0.1 part of carbon black, and 17.9 parts of ion-exchanged water, and the mixture was stirred. A glass bead medium was added to the mixture in a paint conditioner, and was mixed and dispersed in the mixture at room temperature for 1 hour, whereby Coloring Pigment Paste 1 having a particle size of 5 μm or less and a nonvolatile content of 70% was obtained.

### Production Example 8

### Production of Coloring Pigment Paste 2

Coloring Pigment Paste 2 having a nonvolatile content of 70% was obtained in the same manner as in Production Example 7 except that: 62.5 parts of Acrylic-modified Polyester Resin (B) obtained in Production Example 4 were used instead of 50 parts of Acrylic-modified Polyester Resin (A); and 5.4 parts of ion-exchanged water were used instead of 17.9 parts of ion-exchanged water.

### Production Example 9

### Production of Acrylic-Unmodified Polyester Resin (E)

25.6 parts of isophthalic acid, 22.8 parts of phthalic anhydride, 5.6 parts of adipic acid, 19.3 parts of trimethylolpropane, 26.7 parts of neopentyl glycol, 17.5 parts of ε-caprolactone, and 0.1 part of dibutyltin oxide were added to a reaction vessel, and the temperature of the mixture was increased up to 170° C. while the mixture was mixed and stirred. After that, the temperature of the mixture was increased up to 220° C. over 3 hours, and, during the temperature increase, water produced by a condensation reaction was removed until the mixture had an acid value of 8.

Next, 7.9 parts of trimellitic anhydride were added to the resultant, and the whole was subjected to a reaction at 150° C. for 1 hour, whereby a polyester resin having an acid value of 40 was obtained. Further, the resin was cooled to 100° C. Then, 11.2 parts of butyl cellosolve were added to the resin, and the mixture was stirred until the mixture became uniform. After the mixture had been cooled to 60° C., 98.8 parts of ion-exchanged water and 5.9 parts of 2-amino-2-methylpropanol were added to the mixture, whereby Acrylic-unmodified Polyester Resin (E) having a nonvolatile content of 50%, a solid content acid value of 40, a hydroxyl value of 110, and a weight average molecular weight of 8,000 was obtained.

### Production Example 10

### Production of Coloring Pigment Paste 3

50 parts of Acrylic-unmodified Polyester Resin (E) obtained in Production Example 9 were mixed with 34.5 parts of rutile titanium oxide, 34.4 parts of barium sulfate, 6 parts of talc, 0.1 part of carbon black, and 17.9 parts of ion-exchanged water, and the mixture was stirred. A glass bead medium was added to the mixture in a paint conditioner, and was mixed and dispersed in the mixture at room temperature for 1 hour, whereby Coloring Pigment Paste 3 having a particle size of 5 μm or less and a nonvolatile content of 70% was obtained.

### Example 1

### Aqueous Curable Resin Composition 1

The following raw materials were uniformly mixed with a disper, whereby Aqueous Curable Resin Composition 1 was obtained. Aqueous Curable Resin Composition 1 thus obtained was diluted with ion-exchanged water so as to have a viscosity of 40 seconds (measured with a No. 4 Ford cup at 20° C.).

(Raw Materials and Loadings)

| | |
|---|---|
| Acrylic-modified Polyester Resin Solution (A) obtained in | 50 parts |
| Production Example 1; | |
| Acrylic Resin Particles (C) obtained in Production Example | 25 parts |
| 5; | |
| Imino group type methylated melamine resin having a number | 30 parts |
| average molecular weight of 420 and a solid content of | |
| 100 wt % (Mycoat 723, manufactured by Nihon Cytec | |
| Industries, Inc.); | |
| Polyether polyol having a number average molecular weight | 10 parts |
| of 1,000, two hydroxyl groups per molecule, and a solid | |
| content of 100 wt % (Primepol PX-1000, manufactured | |
| by Sanyo Chemical Industries, Ltd.); | |
| Surfactant (Surfynol 104, manufactured by Air Products | 3.8 parts |
| Japan, Inc.); | |
| Organic solvent (butyl cellosolve); | 15 parts |

### Example 2

### Aqueous Curable Resin Composition 2

Aqueous Curable Resin Composition 2 was obtained in the same manner as in Example 1 except that: loading of Acrylic Resin Particle (C) was 50 parts and the melamine resin to be loaded was changed to an imino group type methylated melamine resin having a number average molecular weight of 500 and a solid content of 90 wt % (Cymel 327, manufactured by Nihon Cytec Industries, Inc.) and an imino group type methyl-butyl-mixed melamine resin having a number average molecular weight of 550 and a solid content of 90 wt % (Cymel 212, manufactured by Nihon Cytec Industries, Inc.).

The loading of each of the imino group type methylated melamine resin and the imino group type methyl-butyl-mixed melamine resin was 16.7 parts.

Aqueous Curable Resin Composition 2 thus obtained was diluted with ion-exchanged water so as to have a viscosity of 40 seconds (measured with a No. 4 Ford cup at 20° C.).

### Example 3

### Aqueous Curable Resin Composition 3

Aqueous Curable Resin Composition 3 was obtained in the same manner as in Example 1 except that: the melamine resin to be loaded was changed to an imino group type methylated melamine resin having a number average molecular weight of 500 and a solid content of 90 wt % (Cymel 327, manufactured by Nihon Cytec Industries, Inc.) and an imino group type methyl-butyl-mixed melamine resin having a number average molecular weight of 550 and a solid content of 90 wt % (Cymel 212, manufactured by Nihon Cytec Industries, Inc.); and the polyether polyol to be loaded was changed to a polyether polyol having a number average molecular weight of 600, three hydroxyl groups per molecule, and a solid content of 100 wt % (Sannix GE-600, manufactured by Sanyo Chemical Industries, Ltd.).

The loading of each of the imino group type methylated melamine resin and the imino group type methyl-butyl-mixed melamine resin was 16.7 parts, and the loading of the polyether polyol was 10.0 parts as in the case of Example 1.

Aqueous Curable Resin Composition 3 thus obtained was diluted with ion-exchanged water so as to have a viscosity of 40 seconds (measured with a No. 4 Ford cup at 20° C.).

### Example 4

### Aqueous Curable Resin Composition 4

Aqueous Curable Resin Composition 4 was obtained in the same manner as in Example 1 except that: 9.3 parts of a block isocyanate (Sumidur BL-3175, manufactured by SUMIKA BAYER URETHANE CO., LTD., active ingredient 75%) and 22 parts of an imino group type methylated melamine resin having a number average molecular weight of 500 and a solid content of 90 wt % (Cymel 327, manufactured by Nihon Cytec Industries, Inc.) were further added to the formulation of Example 1; and the polyether polyol to be loaded was changed to a polyether polyol having a number average molecular weight of 600, three hydroxyl groups per molecule, and a solid content of 100 wt % (Sannix GE-600, manufactured by Sanyo Chemical Industries, Ltd.).

Aqueous Curable Resin Composition 4 thus obtained was diluted with ion-exchanged water so as to have a viscosity of 40 seconds (measured with a No. 4 Ford cup at 20° C.).

### Example 5

### Aqueous Curable Resin Composition 5

Aqueous Curable Resin Composition 5 was obtained in the same manner as in Example 1 except that: the acrylic resin particles to be loaded were changed to Acrylic Resin Particles (D) obtained in Production Example 6; the polyether polyol to be loaded was changed to a polyether polyol having a number average molecular weight of 600, three hydroxyl groups per molecule, and a solid content of 100 wt % (Sannix GE-600, manufactured by Sanyo Chemical Industries, Ltd.); and 9.3 parts of a block isocyanate (Sumidur BL-3175, manufactured by SUMIKA BAYER URETHANE CO., LTD., active ingredient 75%) were further added to the formulation of Example 1.

The loading of Acrylic Resin Particles (D) was 13.0 parts, and the loading of the polyether polyol was 10.0 parts as in the case of Example 1.

Aqueous Curable Resin Composition 5 thus obtained was diluted with ion-exchanged water so as to have a viscosity of 40 seconds (measured with a No. 4 Ford cup at 20° C.).

### Example 6

### Aqueous Curable Resin Composition 6

Aqueous Curable Resin Composition 6 was obtained in the same manner as in Example 1 except that: the acrylic-modified polyester resin solution to be loaded was changed to Acrylic-modified Polyester Resin (B) obtained in Production Example 4; the melamine resin to be loaded was changed to an imino group type methylated melamine resin having a number average molecular weight of 500 and a solid content of 90 wt % (Cymel 327, manufactured by Nihon Cytec Industries, Inc.) and an imino group type methyl-butyl-mixed melamine resin having a number average molecular weight of 550 and a solid content of 90 wt % (Cymel 212, manufactured by Nihon Cytec Industries, Inc.); and the polyether polyol to be loaded was changed to a polyether polyol having a number average molecular weight of 600, three hydroxyl groups per molecule, and a solid content of 100 wt % (Sannix GE-600, manufactured by Sanyo Chemical Industries, Ltd.).

The loading of Acrylic-modified Polyester Resin (B) was 62.5 parts, the loading of each of the imino group type methylated melamine resin and the imino group type methyl-butyl-mixed melamine resin was 16.7 parts, and the loading of the polyether polyol was 10.0 parts as in the case of Example 1.

Aqueous Curable Resin Composition 6 thus obtained was diluted with ion-exchanged water so as to have a viscosity of 40 seconds (measured with a No. 4 Ford cup at 20° C.).

### Example 7

### Aqueous Curable Resin Composition 7

Aqueous Curable Resin Composition 7 was obtained in the same manner as in Example 1 except that: the acrylic-modified polyester resin solution to be loaded was changed to Acrylic-modified Polyester Resin (B) obtained in Production Example 4; the loading of the acrylic resin particles was changed to 13 parts; the melamine resin to be loaded was changed to an imino group type methylated melamine resin having a number average molecular weight of 500 and a solid content of 90 wt % (Cymel 327, manufactured by Nihon Cytec Industries, Inc.) and an imino group type methyl-butyl-mixed melamine resin having a number average molecular weight of 550 and a solid content of 90 wt % (Cymel 212, manufactured by Nihon Cytec Industries, Inc.); and 9.3 parts of a block isocyanate (Sumidur BL-3175, manufactured by SUMIKA BAYER URETHANE CO., LTD., active ingredient 75%) were further added.

The loading of Acrylic-modified Polyester Resin (B) was 62.5 parts, the loading of each of the imino group type methylated melamine resin and the imino group type methyl-butyl-mixed melamine resin was 16.7 parts.

Aqueous Curable Resin Composition 7 thus obtained was diluted with ion-exchanged water so as to have a viscosity of 40 seconds (measured with a No. 4 Ford cup at 20° C.).

### Comparative Example 1

### Aqueous Curable Resin Composition C1

Aqueous Curable Resin Composition C1 was obtained in the same manner as in Example 1 except that the acrylic resin particles were removed from the formulation of Example 1.

Aqueous Curable Resin Composition C1 thus obtained was diluted with ion-exchanged water so as to have a viscosity of 40 seconds (measured with a No. 4 Ford cup at 20° C.).

### Example 8

### Aqueous Curable Resin Composition 1

The following raw materials were uniformly mixed with a disper, whereby Aqueous Curable Resin Composition 8 was obtained. Aqueous Curable Resin Composition 8 thus obtained was diluted with ion-exchanged water so as to have a viscosity of 40 seconds (measured with a No. 4 Ford cup at 20° C.).

(Raw Materials and Loadings)

| | |
|---|---|
| Coloring Pigment Paste 1 obtained in Production Example 7; | 142.9 parts |
| Acrylic Resin Particles (C) obtained in Production Example 5; | 25 parts |
| Imino group type methylated melamine resin having a number | 30 parts |
| average molecular weight of 420 and a solid content of 100 wt % (Mycoat | |
| 723, manufactured by Nihon Cytec Industries, Inc.); | |
| Polyether polyol having a number average molecular weight of | 10 parts |
| 1,000, two hydroxyl groups per molecule, and a solid content of | |
| 100 wt % (Primepol PX-1000, manufactured by Sanyo Chemical Industries, | |
| Ltd.); | |
| Surfactant (Surfynol 104, manufactured by Air Products Japan, | 3.8 parts |
| Inc.); | |
| Organic solvent (butyl cellosolve); | 15 parts |

### Example 9

### Aqueous Curable Resin Composition 9

Aqueous Curable Resin Composition 9 was obtained in the same manner as in Example 8 except that: the loading of Acrylic Resin Particles (C) was 50 parts and the melamine resin to be loaded was changed to an imino group type methylated melamine resin having a number average molecular weight of 500 and a solid content of 90 wt % (Cymel 327, manufactured by Nihon Cytec Industries, Inc.) and an imino group type methyl-butyl-mixed melamine resin having a number average molecular weight of 550 and a solid content of 90 wt % (Cymel 212, manufactured by Nihon Cytec Industries, Inc.).

The loading of each of the imino group type methylated melamine resin and the imino group type methyl-butyl-mixed melamine resin was 16.7 parts.

Aqueous Curable Resin Composition 9 thus obtained was diluted with ion-exchanged water so as to have a viscosity of 40 seconds (measured with a No. 4 Ford cup at 20° C.).

### Example 10

### Aqueous Curable Resin Composition 10

Aqueous Curable Resin Composition 10 was obtained in the same manner as in Example 8 except that: the melamine resin to be loaded was changed to an imino group type methylated melamine resin having a number average molecular weight of 500 and a solid content of 90 wt % (Cymel 327, manufactured by Nihon Cytec Industries, Inc.) and an imino group type methyl-butyl-mixed melamine resin having a number average molecular weight of 550 and a solid content of 90 wt % (Cymel 212, manufactured by Nihon Cytec Industries, Inc.); and the polyether polyol to be loaded was changed to a polyether polyol having a number average molecular weight of 600, three hydroxyl groups per molecule, and a solid content of 100 wt % (Sannix GE-600, manufactured by Sanyo Chemical Industries, Ltd.).

The loading of each of the imino group type methylated melamine resin and the imino group type methyl-butyl-mixed melamine resin was 16.7 parts, and the loading of the polyether polyol was 10.0 parts as in the case of Example 8.

Aqueous Curable Resin Composition 10 thus obtained was diluted with ion-exchanged water so as to have a viscosity of 40 seconds (measured with a No. 4 Ford cup at 20° C.).

### Example 11

### Aqueous Curable Resin Composition 11

Aqueous Curable Resin Composition 11 was obtained in the same manner as in Example 8 except that: 9.3 parts of a block isocyanate (Sumidur BL-3175, manufactured by SUMIKA BAYER URETHANE CO., LTD., active ingredient 75%) and 22 parts of an imino group type methylated melamine resin having a number average molecular weight of 500 and a solid content of 90 wt % (Cymel 327, manufactured by Nihon Cytec Industries, Inc.) were further added to the formulation of Example 8; and the polyether polyol to be loaded was changed to a polyether polyol having a number average molecular weight of 600, three hydroxyl groups per molecule, and a solid content of 100 wt % (Sannix GE-600, manufactured by Sanyo Chemical Industries, Ltd.).

The loading of polyether polyol was 10.0 parts as in the case of Example 8.

Aqueous Curable Resin Composition 11 thus obtained was diluted with ion-exchanged water so as to have a viscosity of 40 seconds (measured with a No. 4 Ford cup at 20° C.).

### Example 12

### Aqueous Curable Resin Composition 12

Aqueous Curable Resin Composition 12 was obtained in the same manner as in Example 8 except that: the acrylic resin particles to be loaded were changed to Acrylic Resin Particles (D) obtained in Production Example 6; the polyether polyol to be loaded was changed to a polyether polyol having a number average molecular weight of 600, three hydroxyl groups per molecule, and a solid content of 100 wt % (Sannix GE-600, manufactured by Sanyo Chemical Industries, Ltd.); and 9.3 parts of a block isocyanate (Sumidur BL-3175, manufactured by SUMIKA BAYER URETHANE CO., LTD., active ingredient 75%) were further added to the formulation of Example 8.

The loading of Acrylic Resin Particles (D) was 13.0 parts, and the loading of the polyether polyol was 10.0 parts as in the case of Example 8.

Aqueous Curable Resin Composition 12 thus obtained was diluted with ion-exchanged water so as to have a viscosity of 40 seconds (measured with a No. 4 Ford cup at 20° C.).

### Example 13

### Aqueous Curable Resin Composition 13

Aqueous Curable Resin Composition 13 was obtained in the same manner as in Example 8 except that: the coloring pigment paste to be loaded was changed to Coloring Pigment Paste 2 obtained in Production Example 8; the melamine resin to be loaded was changed to an imino group type methylated melamine resin having a number average molecular weight of 500 and a solid content of 90 wt % (Cymel 327, manufactured by Nihon Cytec Industries, Inc.) and an imino group type methyl-butyl-mixed melamine resin having a number average molecular weight of 550 and a solid content of 90 wt % (Cymel 212, manufactured by Nihon Cytec Industries, Inc.); and the polyether polyol to be loaded was changed to a polyether polyol having a number average molecular weight of 600, three hydroxyl groups per molecule, and a solid content of 100 wt % (Sannix GE-600, manufactured by Sanyo Chemical Industries, Ltd.).

The loading of Coloring Pigment Paste 2 was 142.9 parts as in the case of Example 8, the loading of each of the imino group type methylated melamine resin and the imino group type methyl-butyl-mixed melamine resin was 16.7 parts, and the loading of the polyether polyol was 10.0 parts as in the case of Example 8.

Aqueous Curable Resin Composition 13 thus obtained was diluted with ion-exchanged water so as to have a viscosity of 40 seconds (measured with a No. 4 Ford cup at 20° C.).

### Example 14

### Aqueous Curable Resin Composition 14

Aqueous Curable Resin Composition 14 was obtained in the same manner as in Example 8 except that: the coloring pigment paste to be loaded was changed to Coloring Pigment Paste 2 obtained in Production Example 8; the loading of the Acrylic Resin Particles (C) was changed to 13 parts; the melamine resin to be loaded was changed to an imino group type methylated melamine resin having a number average molecular weight of 500 and a solid content of 90 wt % (Cymel 327, manufactured by Nihon Cytec Industries, Inc.) and an imino group type methyl-butyl-mixed melamine resin having a number average molecular weight of 550 and a solid content of 90 wt % (Cymel 212, manufactured by Nihon Cytec Industries, Inc.); and 9.3 parts of a block isocyanate (Sumidur BL-3175, manufactured by SUMIKA BAYER URETHANE CO., LTD., active ingredient 75%) were further added.

The loading of Coloring Pigment Paste 2 was 142.9 parts as in the case of Example 8, the loading of each of the imino group type methylated melamine resin and the imino group type methyl-butyl-mixed melamine resin was 16.7 parts.

Aqueous Curable Resin Composition 14 thus obtained was diluted with ion-exchanged water so as to have a viscosity of 40 seconds (measured with a No. 4 Ford cup at 20° C.).

### Example 15

### Aqueous Coating Composition 15

Aqueous Coating Composition 15 was obtained in the same manner as in Example 8 except that 0.5 part of a Primal ASE-60 (manufactured by Rohm & Haas) was added as a thickening agent.

Aqueous Curable Resin Composition 15 thus obtained was diluted with ion-exchanged water so as to have a viscosity of 40 seconds (measured with a No. 4 Ford cup at 20° C.).

### Comparative Example 2

### Aqueous Coating Composition C2

Aqueous Coating Composition C2 was obtained in the same manner as in Example 8 except that the acrylic resin particles were removed from the formulation of Example 8.

Aqueous Curable Resin Composition C2 thus obtained was diluted with ion-exchanged water so as to have a viscosity of 40 seconds (measured with a No. 4 Ford cup at 20° C.).

### Comparative Example 3

### Aqueous Coating Composition C3

Aqueous Coating Composition C3 was obtained in the same manner as in Example 8 except that the coloring pigment paste to be loaded was changed to Coloring Pigment Paste 3 obtained in Production Example 10.

Aqueous Coating Composition C3 thus obtained was diluted with ion-exchanged water so as to have a viscosity of 40 seconds (measured with a No. 4 Ford cup at 20° C.).

### [Evaluation Test]

(Measurement of Nonvolatile Content of Resin Composition)

Table 1 shows the solid content concentration (nonvolatile content concentration) of each of the aqueous curable resin compositions obtained in Examples 1 to 7 and Comparative Example 1.

(Production of Test Sheet)

A dull steel sheet treated with zinc phosphate and measuring 300 mm wide by 400 mm long by 0.8 mm thick as a product to be coated was subjected to electrodeposition coating with a cation electrodeposition coating (Power Top U-50, manufactured by NIPPON PAINT Co., Ltd.) so that a coating film to be obtained would have a thickness of 20 μm in a dry state. The resultant was cured by heating at 160° C. for 30 minutes. The resultant coated sheet was defined as an electrodeposition coating sheet to be used in the following maximum anti-sagging film thickness measurement.

In addition, the coated sheet subjected to electrodeposition coating and cured by heating at 160° C. for 30 minutes by the above procedure was coated with Aqueous Coating Composition 8 of Example 8 in one stage by using a Cartridge Bell (rotary atomizing electrostatic coater for coating with an aqueous coating manufactured by ABB Industries) so that a coating film to be obtained would have a thickness of 30 μm in a dry state, and the whole was preheated at 80° C. for 3 minutes. After that, the resultant was cured by heating at 150° C. for 30 minutes, and was then cooled.

It should be noted that a test sheet was produced by the same procedure as that described above for each of Aqueous Coating Compositions 9 to 14, C2, and C3 obtained in Examples 9 to 14, and Comparative Examples 2 and 3.

(Production of Comparative Test Sheet)

A dull steel sheet was coated with a solvent type intermediate coating (manufactured by NIPPON PAINT Co., Ltd., Orga P-30 Gray) and cured by heating by the same procedure as that described above, whereby a comparative test sheet was obtained.

(Finished External Appearance)

A test sheet cured by heating at 150° C. for 30 minutes was cooled, and was then visually evaluated for its finished external appearance. The result of the evaluation was compared with the result of the observation of the comparative test sheet. Table 2 shows the results.

Evaluation criteria are as shown below. It should be noted that B corresponds to the level at which the test sheet causes no problem in practical use.

A: A finished external appearance is superior to that in the case where the solvent type intermediate coating is used.

B: A finished external appearance is comparable to that in the case where the solvent type intermediate coating is used.

C: A finished external appearance is inferior to that in the case where the solvent type intermediate coating is used.

(Substrate-Hiding Property)

The substrate-hiding property of each test sheet was measured with a Wave Scan (surface roughness tester manufactured by BYK-Chemie GmbH), whereby a measured value (W3 value) in a short wavelength region of 320 to 800 μm effective for substrate-hiding property was obtained. A measured value of 30 or less was accepted. Table 2 shows the results of the measurement.

(Maximum Anti-Sagging Film Thickness Measurement)

The above electrodeposition coating sheet perforated with a hole having a diameter of 5 mm was coated with each of Aqueous Coating Compositions 8 to 14, C2, and C3 with a gradient by using a Cartridge Bell so that the thickness of a coating film to be obtained might vary. Immediately after the coating, the sheet was vertically raised, set in the state for 5 minutes, and, furthermore, preheated at 80° C. for 3 minutes. After that, the sheet was cured by heating at 150° C. for 30 minutes while being kept vertical. The thickness of the coating film dripping below the 5-mm hole by a length of 5 mm after the curing was defined as a maximum anti-sagging film thickness. A maximum anti-sagging film thickness of 35 μm or more was accepted. Table 2 shows the results.

TABLE 1

| | | | | | | | | | Comparative |
|---|---|---|---|---|---|---|---|---|---|
| | | Example 1 | Example 2 | Example 3 | Example 4 | Example 5 | Example 6 | Example 7 | Example 1 |
| Aqueous curable resin | | 1 | 2 | 3 | 4 | 5 | 6 | 7 | C1 |
| composition | | | | | | | | | |
| Acrylic-modified Polyester | | 50 | 50 | 50 | 50 | 50 | — | — | 50 |
| Resin Solution (A) | | | | | | | | | |
| Acrylic-modified Polyester | | — | — | — | — | — | 62.5 | 62.5 | — |
| Resin Solution (B) | | | | | | | | | |
| Acrylic Resin Water | | 25 | 50 | 25 | 25 | — | 25 | 13 | — |
| Dispersion (C) | | | | | | | | | |
| Acrylic Resin Water | | — | — | — | — | 13 | — | — | — |
| Dispersion (D) | | | | | | | | | |
| Melamine resin | Mycoat 723 | 30 | — | — | 30 | 30 | — | — | 30 |
| | Cymel 327 | — | 16.7 | 16.7 | 22 | — | 16.7 | 16.7 | — |
| | Cymel 212 | — | 16.7 | 16.7 | — | — | 16.7 | 16.7 | — |
| Polyether | Primepol | 10 | 10 | — | — | — | — | 10 | 10 |
| polyol | PX-100 | | | | | | | | |
| | Sannix | — | — | 10 | 10 | 10 | 10 | — | — |
| | GE-600 | | | | | | | | |
| Block | Sumidur | — | — | — | 9.3 | 9.3 | — | 9.3 | — |
| polyisocyanate | BL-3175 | | | | | | | | |
| Surfactant | Surfynol 104 | 3.8 | 3.8 | 3.8 | 3.8 | 3.8 | 3.8 | 3.8 | 3.8 |
| Organic solvent | Butyl | 15 | 15 | 15 | 15 | 15 | 15 | 15 | 15 |
| | cellosolve | | | | | | | | |

| | | | | | | | | |
|---|---|---|---|---|---|---|---|---|
| Solid content concentration | 40.8 | 42.2 | 40.2 | 41.5 | 40.6 | 41.8 | 41.3 | 36.4 |
| (%) | | | | | | | | |

TABLE 2

| | | | | | | | | | | Com- | Com- |
|---|---|---|---|---|---|---|---|---|---|---|---|
| | | | | Example | Example | Example | Example | Example | Example | parative | parative |
| | | Example 8 | Example 9 | 10 | 11 | 12 | 13 | 14 | 15 | Example 2 | Example 3 |
| Aqueous coating composition | | 8 | 9 | 10 | 11 | 12 | 13 | 14 | 15 | C2 | C3 |
| Coloring Pigment Paste 1 | | 142.9 | 142.9 | 142.9 | 142.9 | 142.9 | — | — | 142.9 | 142.9 | — |
| Coloring Pigment Paste 2 | | — | — | — | — | — | 142.9 | 142.9 | — | — | — |
| Coloring Pigment Paste 3 | | — | — | — | — | — | — | — | — | — | 142.9 |
| Acrylic Resin Particles (C) | | 25 | 50 | 25 | 25 | — | 25 | 13 | 25 | — | 25 |
| Acrylic Resin Particles (D) | | — | — | — | — | 13 | — | — | — | — | — |
| Melamine | Mycoat 723 | 30 | — | — | 30 | 30 | — | — | 30 | 30 | 30 |
| resin | Cymel 327 | — | 16.7 | 16.7 | 22 | — | 16.7 | 16.7 | — | — | — |
| | Cymel 212 | — | 16.7 | 16.7 | — | — | 16.7 | 16.7 | — | — | — |
| Polyether | Primepol | 10 | 10 | — | — | — | — | 10 | 10 | 10 | 10 |
| polyol | PX-100 | | | | | | | | | | |
| | Sannix | — | — | 10 | 10 | 10 | 10 | — | — | — | — |
| | GE-600 | | | | | | | | | | |
| Block | Sumidur | — | — | — | 9.3 | 9.3 | — | 9.3 | — | — | — |
| polyisocyanate | BL-3175 | | | | | | | | | | |
| Surfactant | Surfynol | 3.8 | 3.8 | 3.8 | 3.8 | 3.8 | 3.8 | 3.8 | 3.8 | 3.8 | 3.8 |
| | 104 | | | | | | | | | | |
| Organic | Butyl | 15 | 15 | 15 | 15 | 15 | 15 | 15 | 15 | 15 | 15 |
| solvent | cellosolve | | | | | | | | | | |
| Thickening | Primal | — | — | — | — | — | — | — | 0.5 | — | — |
| agent | ASE-60 | | | | | | | | | | |

| | | | | | | | | | | |
|---|---|---|---|---|---|---|---|---|---|---|
| Solid content concentration | 57.2 | 59.2 | 56.8 | 57.4 | 56.9 | 57.8 | 57.1 | 56.8 | 53.3 | 56.5 |
| (%) | | | | | | | | | | |
| Finished external appearance | A | A | B | A | A | A | B | B | A | C |
| WS (W3) | 18 | 17 | 22 | 20 | 21 | 17 | 21 | 24 | 25 | 36 |
| Maximum anti-sagging | 41 | 36 | 45 | 42 | 38 | 46 | 39 | 47 | 28 | 41 |
| film thickness (μm) | | | | | | | | | | |

As is apparent from Table 1, the aqueous curable resin composition of the present invention can have an increased solid content concentration. In addition, as is apparent from Table 2, the aqueous coating composition of the present invention using the aqueous curable resin composition of the present invention can have an increased solid content concentration, provides a coating film excellent in finished external appearance, and is significantly excellent in both substrate-hiding property and coating workability.

Each of the aqueous curable resin composition and aqueous coating composition of the present invention can be suitably used for coating, for example, the outside plate of a vehicle such as an automobile or a two wheeler, a part, the external surface of a container, a coil coating, a household electrical appliance, or steel furniture.

Many other modifications will be apparent to and be readily practiced by those skilled in the art without departing from the scope and spirit of the invention. It should therefore be understood that the scope of the appended claims is not intended to be limited by the details of the description but should rather be broadly construed.

1. An aqueous curable resin composition, comprising:
a (meth)acrylic-modified polyester resin;
(meth)acrylic resin particles having an average particle diameter of 0.1 to 2 μm;
a melamine resin; and
water.

2. An aqueous curable resin composition according to claim 1, wherein the (meth)acrylic-modified polyester resin is incorporated at a content of 20 to 90 parts by weight with respect to 100 parts by weight of a total resin solid content in the aqueous curable resin composition.

3. An aqueous curable resin composition according to claim 1, wherein the (meth)acrylic-modified polyester resin is obtained by subjecting an unsaturated polyester resin and a polymerizable unsaturated (meth)acrylic monomer containing a carboxyl group-containing polymerizable unsaturated monomer to graft polymerization.

4. An aqueous curable resin composition according to claim 1, wherein the (meth)acrylic-modified polyester resin is obtained by causing a (meth)acrylic-modified fatty acid to react with a hydroxyl group-containing polyester resin.

5. An aqueous curable resin composition according to claim 1, wherein the (meth)acrylic resin particles are incorporated at a content of 1 to 30 parts by weight with respect to 100 parts by weight of the total resin solid content in the aqueous curable resin composition.

6. An aqueous curable resin composition according to claim 1, wherein the (meth)acrylic resin particles have an average particle diameter of 0.3 to 1 μm.

7. An aqueous curable resin composition according to claim 1, wherein each of the (meth)acrylic resin particles has a solubility parameter SP of 9 to 12.

8. An aqueous curable resin composition according to claim 1, wherein the melamine resin comprises an imino group type melamine resin.

9. An aqueous curable resin composition according to claim 1, wherein the melamine resin is incorporated at a content of 10 to 40 parts by weight with respect to 100 parts by weight of the total resin solid content in the aqueous curable resin composition.

10. An aqueous curable resin composition according to claim 1, further comprising a polyether polyol having a number average molecular weight of 400 to 1,500.

11. An aqueous curable resin composition according to claim 10, wherein the polyether polyol is incorporated at a content of 3 to 30 parts by weight with respect to 100 parts by weight of the total resin solid content in the aqueous curable resin composition.

12. An aqueous curable resin composition according to claim 10, wherein the number of hydroxyl groups in one molecule of the polyether polyol is 6 or less.

13. An aqueous curable resin composition according to claim 1, further comprising a block polyisocyanate compound.

14. An aqueous curable resin composition according to claim 13, wherein the block polyisocyanate compound is incorporated at a content of 3 to 30 parts by weight with respect to 100 parts by weight of the total resin solid content in the aqueous curable resin composition.

15. An aqueous curable resin composition according to claim 1, further comprising at least one of a urethane association type thickening agent and an alkali-thickening type thickening agent having a carboxylic acid neutralizing group.

16. An aqueous curable resin composition according to claim 15, wherein the at least one thickening agent is incorporated at a content of 0.01 to 10 parts by weight with respect to 100 parts by weight of the total resin solid content in the aqueous curable resin composition.

17. An aqueous coating composition, comprising:
the aqueous curable resin composition according to claim 1; and
a pigment.

18. An aqueous coating composition according to claim 17, wherein the pigment contains a flat pigment.

19. An aqueous coating composition according to claim 18, wherein the flat pigment is incorporated at a content of 1 to 12 parts by weight with respect to 100 parts by weight of the pigment.

20. An aqueous coating composition, comprising:
the aqueous curable resin composition according to claim 2; and
a pigment.
